(19) United States
(12) Patent Application Publication
(10) Pub. No.: US 2008/0298913 A1
(43) Pub. Date: Dec. 4, 2008

(54) Increased Process Damping Via Mass Reduction for High Performance Milling

(75) Inventors: Keith A. Young, St. Peters, MO (US); Eric J. Stern, Valmeyer, IL (US); Thomas L. Talley, Granite City, IL (US); Randolph B. Hancock, St. Peters, MO (US)

Correspondence Address: THE BOEING COMPANY;c/o FELIX L. FISCHER, ATTORNEY AT LAW, 1607 MISSION DRIVE, SUITE 204, SOLVANG, CA, 93463, US

(73) Assignee: THE BOEING COMPANY, Chicago, IL (US)

(21) Appl. No.: 11/757,547

(22) Filed: Jun. 4, 2007

(51) Int. Cl. B23B 47/00

(52) U.S. Cl. 408/143

(57) ABSTRACT

A cutting tool incorporates a body terminating in cutting edges distal from a chuck mount and having an axial bore for reduced mass to raise from a steel or carbide blank into a cylindrical pipe forming the hollow bore prior to grinding of the cutting edges. Filling of the bore with a light polymer to further absorb vibration can also be employed.

### FIELD

This invention related generally to the metals machining and more particularly to a bore relieved milling tool having reduced mass for process damping and high performance milling.

### BACKGROUND

Finish Machining of deep pocket aircraft structural components is limited by deflection and chatter. Modern designers are consistently pursuing weight reduction opportunities in metallic structure. Machined parts with deep pockets and small corner radii require long slender end mills ti cut the corners. Long slender cutting tools are more susceptivle to chatter and vibration than shorter more rigid tools. Long cutting tools exhibit lower natural frequencies, which reduces the process damping effects which can stabilize chatter. This requires small cuts and slower cutting speeds to avoid chatter, which can increase manufacturing costs. Current methods to increase machining rates include using higher speeds and tools with more cutting edges. Both of these techniques can result in more chatter for longer cutting tools.

Current methods exist to reduce cutting tool vibration and chatter. These include using an eccentric relief on the cutting tool to enhance the rubbing of the cutter on the machined part. This rubbing will also stabilize the cutting tool. The use of an eccentric relief is a benefit for shorter cutting tools, but the effect is not useful for longer tools, when the resonant frequency of the cutting tool creates a wavelength that is longer than the eccentric relief.

It is therefore desirable to provide modified cutting tools which retain or increase process damping effects to stabilize chatter.

### SUMMARY

The embodiments disclosed herein provide a cutting tool incorporating a body terminating in cutting edges distal from a chuck mount and having an axial bore. In certain of the embodiments, the body is preformed from a steel or carbide blank a cylindrical pipe forming the hollow bore.

In alternative embodiments, the avial bore is filled with a vibration absorbing material. A light weight polymer is used in exemplary embodiments.

### BRIEF DESCRIPTION OF THE DRAWINGS

These and other features and advantages of the present invention will be better understood by reference to the following detailed description when considered in connection with the accompanying drawing wherein:

FIG. 1 is an isometric side view of an embodiment of the reduced mass tool;

FIG. 2 is a bottom axial view of the embodiment of FIG. 1;

FIG. 3 is a side view of the embodiment of FIG. 1;

FIG. 4 is an isometric view of a filled embodiment of the tool;

FIG. 5 is an illustration of the cutting profile effects of the low frequency vibration in a tool without process damping;

FIG. 6 is an illustration of the cutting profile with process damping provided by a tool incoporating the present invention;

FIG. 7 is a graph depicting stability lobes for depths of cut with respect to cutting speed for a tool without process damping; and,

FIG. 8 is a graph depicting resulting stability lobes for depth of the cut with respect to cutting speed for a tool employing process damping provided by the present invention.

### DETAILED DESCRIPTION

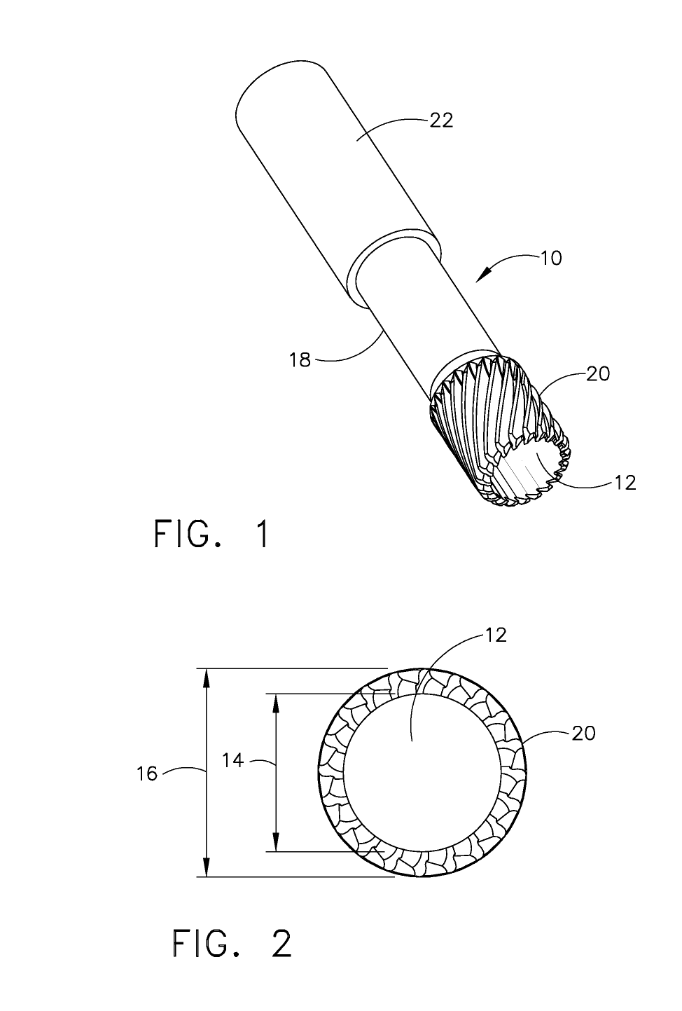

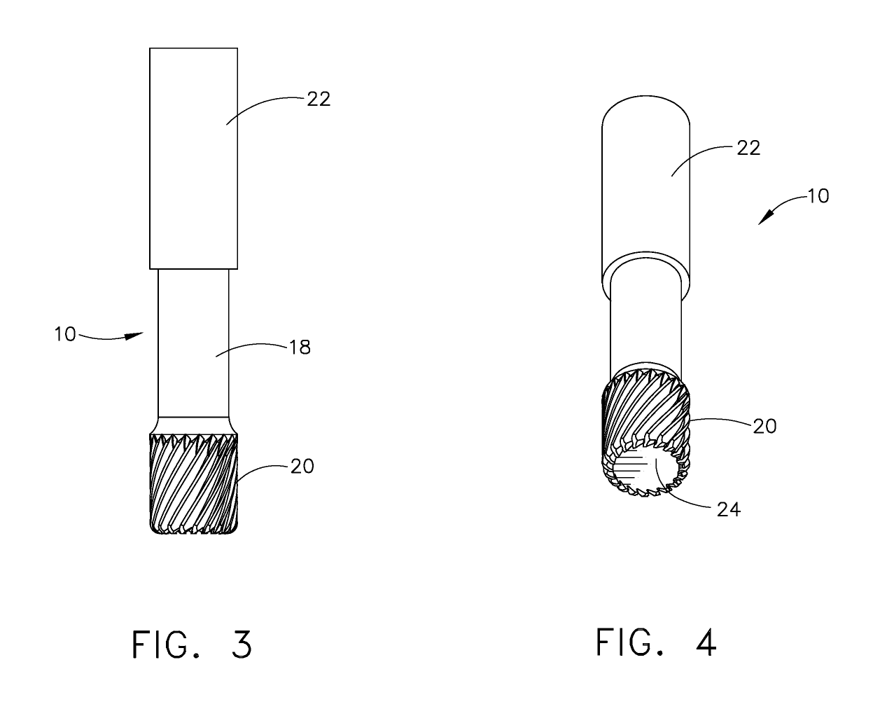

The embodiments of the tool disclosed herein are applicable to rotating milling cutter and stationary boring cutters where the work piece rotates instead of the tool. As shown in FIG. 1, an embodiment of the reduced mass tool 10 is hollow; incorporating a center bore 12. FIG. 2 demonstrates that for this embodiment, the center bore employs a large diameter 14 with respect to the overall diameter of the tool 16 and is aligned with the axis of rotation of the tool. Additionally, the tool shank 18 is necked down or relieved to further reduce mass with the cutting edges 20 formed at a first end of the tool and a chuck attachment 22 formed at the opposite end.

The cutting tool mass is reduced by pre-forming the carbide or steel blank into a cylindrical pipe before grinding the cutting edges. For the embodiment shown, a reduction of over half the mass of a conventional tool is achieved. The mass reduced form increases the resonant frequency of a milling cutter, as the example embodiment, without significantly reducing the tool stiffness. This allows the tool to cut with approximately the same static deflection, but with significantly reduced dynamic deflection and chatter, as will be discussed in greater detail subsequently. In alternative embodiments, boring of the center hole in the completed tool or prior to heat treating or sintering and grinding of cutting edges is accomphished.

In alternative embodiments, the large hole in the center of the cutting tool is filled with a vibration absorbing material such as light weight polymer 24 as shown in FIG. 4 to further absorb vibration. An exemplary polymer is silicon RTV 664B produced by General Electric. Alternative filler materials such as metallic or nonmetallic shot or pellets, a viscious liquid, oil or water, a resin, or another metal with higher material damping are anticipated in exemplary embodiments.

Testing of embodiments shown herein has shown a significant reduction in cutter vibration. The cutting tool with less mass vibrated at a higher frequency. The natural frequency, Wn, of the resulting mechanical system is given by Wn=sqrt(k/m), where k is the stiffness and m is the mass. As mass is reduced, the natural frequency is increased by the square root of the mass. Dynamic stiffness of the cutter is measured using impact testing with an accelerometer attached to the tool. By striking the tool with a mallet, the dynamic stiffness of the cutter is reported by a displacement Frequency Response Function (FRF) monitored on an oscilloscope output from the accelerometer. Tuning of resonant frequency by modifying the central hole diameter in the cutting tool can be accomplished for specific machining requirements such as tool rotational speed as desired. However, for most embodiments, achieving the highest frequency while maintaining necessary tool stiffness is desirable.

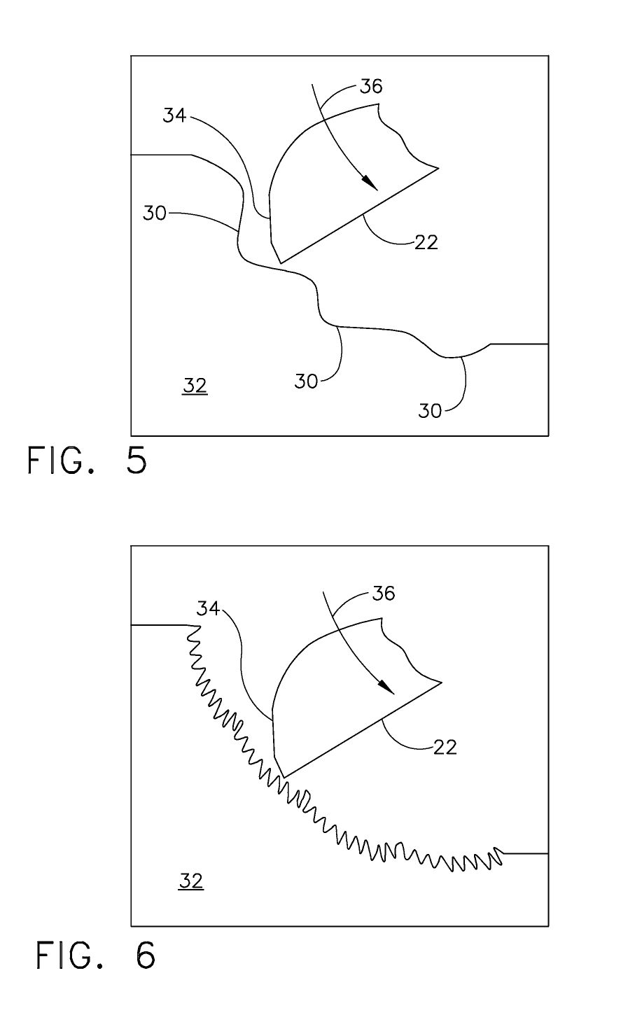

Creating higher frequency response on the tool allows smearing by an eccentric relief or clearance ramp 34 of the tool which is not possible at lower frequency. As shown in FIG. 5, low frequency vibration of a tool without incorporation of the present invention created cutting scallops 30 in working machine part 32 which exceed the effective capability of clearance ramp 34 on cutting edge 20 with tool rotational direction generally indicated by arrow 36. FIG. 6 demonstrates the higher frequency contact of the cutting edge in a tool comparable to the disclosed embodiments providing a smoother surface. For the embodiment shown, the clearance ramp is modified to incorporate a eccentric relief grind to enhance smearing on the rake face.

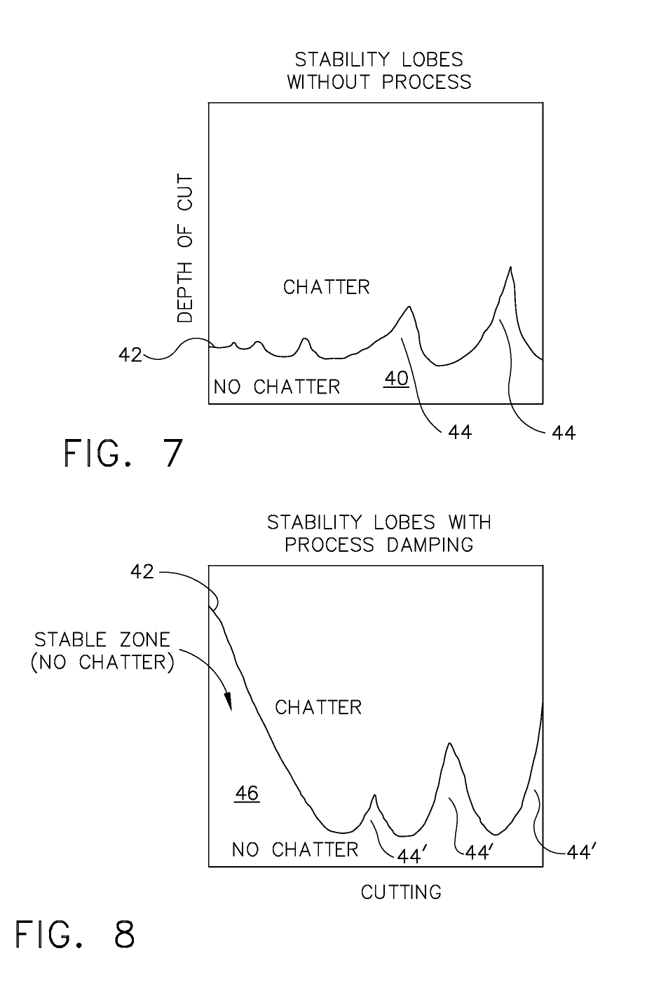

Similarly, a stability zone prior to onset of chatter of the tool is achieved for cuts of greater depth as shown in FIGS. 7 and 8. For a tool without the present invention, the “no chatter” region 40 is limited to a an onset value 42 for depth of cut based on cutting speed as shown in FIG. 7. Certain stability lobes 44 are present at higher cutting speeds. Employing the present invention provides a significant stability zone 46 to a much higher onset value for chatter as shown in FIG. 8. Additionally, the stability lobes 44′ are increased in area providing increased functionality for machining soft metals. The tool frequency changes via mass removal can be employed to align a stability lobe with the top speed of a spindle for improved machining rates.

The embodiments disclosed have been tested and provide the ability for use for pockets up to 4 inches in depth. At this depth, the new hollow reduced mass cutting tool is more than twice as productive as a prior art solid counterpart. Pockets of up to 8 inches in depth are anticipated to be within the capability of the tool. The embodiments disclosed herein allow more productive use of long, slender end mills, which are traditionally problematic.

Having now described exemplary embodiments for the invention in detail as required by the patent statutes, those skilled in the art will recognize modifications and substitutions to the specific embodiments disclosed herein. Such modifications are within the scope and intent of the present invention as defined in the following claims.

1. A cutting tool comprising:
a body terminating in cutting edges distal from a chuck mount, the body having an axial bore.

2. A cutting tool as defined in claim 1 wherein the body is preformed into a cylindrical pipe.

3. A cutting tool as defined in claim 2 wherein the pipes is formed from a carbide blank.

4. A cutting tool as defined in claim 2 wherein the pipe is formed from a steel blank.

5. A cutting tool as defined in claim 1 wherein the axial bore is filled with a vibration absorbing material.

6. A cutting tool as defined in claim 5 wherein the vibration absorbing material is a light weight polymer.

7. (canceled)

8. A cutting tool as defined in claim 5 wherein the vibration absorbing material is selected from the set of metallic or nonmetallic shot or pellets, a viscous liquid, oil or water, a resin, or a metal dissimilar to the body with higher material damping.

9. A cutting tool as defined in claim 1 wherein the body is relieved intermediate the chuck mount and cutting edges.

10. A method to reduce the vibration of a cutting tool comprising the step of:
reducing the cutting tool mass by pre-forming a carbide or steel blank into a cylindrical pipe as a tool body.

11. A method as defined in claim 10 wherein the step of reducing the cutting tool mass is accomplished before an additional step of grinding cutting edges at one end of the tool body.

12. A method as defined in claim 10 comprising the additional step of: filling the hollow center of the pipe with a vibration damping material.

13. The method as defined in claim 12 wherein the vibration absorbing material is a light weight polymer.

14. The method as defined in claim 13 wherein the light weight polymer is Silicone RTV.

15. The method as defined in claim 12 wherein the vibration absorbing material is selected from the set of metallic or nonmetallic shot or pellets, a viscous liquid, oil or water, a resin, or a metal dissimilar to the body with higher material damping.

16. A method as defined in claim 11 further comprising the step of machining the tool body intermediate the cutting edges and a chuck mount distal the cutting edges to further reduce the tool mass.

17. A method for fabrication of a cutting tool comprising the steps of:
providing a tool body with a hollow bore;
grinding cutting edges at one end of the tool body.

18. A method as defined in claim 17 wherein the step of providing the tool body comprises pre-forming a carbide or steel blank into a cylindrical pipe as the tool body.

19. A method as defined in claim 17 wherein the step of providing the tool body comprises the steps of:
providing a cylindrical tool body;
drilling an axial bore in the tool body.

20. A method as defined in claim 17 further comprising the step of filling the hollow bore with a vibration absorbing material.

21. The method as defined in claim 20 wherein the vibration absorbing material is a light weight polymer.

22. The method as defined in claim 21 wherein the light weight polymer is Silicone RTV.

23. The method as defined in claim 20 wherein the vibration absorbing material is selected from the set of metallic or nonmetallic shot or pellets, a viscous liquid, oil or water, a resin, or a metal dissimilar to the body with higher material damping.

24. A method as defined in claim 17 further comprising the step of machining the tool body intermediate the cutting edges and a chuck mount distal the cutting edges to further reduce the tool mass.

25. A method of machining comprising the steps of:
providing a tool body with a hollow bore;
grinding cutting edges at on end of the bore;
mounting the tool body in a machine tool chuck;
maximizing cutting depth by operating at a cutting speed within a no chatter zone increased based on reduced mass of the tool body.

26. A cutting tool as defined in claim 6 wherein the light weight polymer is Silicone RTV.
